(19) United States
(12) Patent Application Publication
(10) Pub. No.: US 2025/0380181 A1
(43) Pub. Date: Dec. 11, 2025

(54) Adjusting Priority of 5G Standalone Traffic at a gNodeB

(71) Applicant: AT&T Intellectual Property I, L.P., Atlanta, GA (US)

(72) Inventors: Haywood Peitzer, Randolph, NJ (US); Yunpeng Li, Austin, TX (US)

(73) Assignee: AT&T Intellectual Property I, L.P., Atlanta, GA (US)

(21) Appl. No.: 18/738,170

(22) Filed: Jun. 10, 2024

(51) Int. Cl. H04W 28/02; H04W 76/12

(52) U.S. Cl. CPC H04W 28/0268; H04W 76/12

(57) ABSTRACT

Adjusting priority of 5G standalone traffic at a gNodeB can include detecting, at a gNodeB of a mobility network, a connection with a user equipment and examining, by the gNodeB, a connection request associated with the user equipment. The connection request can include bearer information. The gNodeB can determine if the user equipment is requesting 5G standalone services. In response to a determination that the user equipment is requesting the 5G standalone communications, the gNodeB can adjust a priority to be used for the communications associated with the user equipment to obtain an adjusted priority for a connection associated with the 5G standalone communications. The gNodeB also can tunnel communications between the gNodeB and a 5G core of the mobility network. The communications associated with the 5G standalone communications can be provided by the mobility network at the adjusted priority.

### BACKGROUND

Network operators often invest large percentages of profits into improving and/or evolving networks to support new features and/or to provide existing features at improved quality-of-service and/or improved reliability. As new network equipment is installed to support evolved and/or improved services, however, adoption of the new services may be limited and/or delayed by subscriber equipment and/or equipment limitations. For example, new spectrum allocations may or may not be supported by some older devices, and therefore evolved networks often are required to support more than one network technology at any given time. This, in turn, can delay the adoption of new services and negatively impact the perceived quality of service attainable by some devices.

In some instances, new services that are enabled to provide improved service may not perform at an improved level due to users and/or their devices requesting older versions of the services. Thus, adoption of new technologies may be delayed, and user satisfaction may be diminished. As a result, investment in new network technologies may be wasted.

### SUMMARY

The present disclosure is directed to adjusting priority of 5G standalone traffic at a gNodeB. In particular, various embodiments of the concepts and technologies disclosed herein can include raising a priority of traffic associated with user equipment requesting 5G standalone (sometimes referred to “5G SA”) services relative to other user equipment requesting 5G non-standalone (sometimes referred to as “5G NSA”) services. By raising the priority of traffic associated with user equipment requesting 5G standalone services, the quality-of-service (“QoS”) experienced by devices and/or users requesting 5G standalone services can be better than the QoS experienced by users and/or devices requesting 5G non-standalone services. Improved QoS can speed the adoption of 5G standalone services, thereby improving QoS for many users, speeding adoption of evolved network services and/or speeding the evolution of network services, and/or result in some other benefits in various embodiments. It should be understood that this example embodiment is illustrative, and therefore should not be construed as being limiting in any way.

In some embodiments, a user equipment can connect to a network such as a mobility network that supports fourth generation (“4G”) services and/or fifth generation (“5G”) services. The user equipment may request services from the network, for example via a connection request that may include bearer information and/or other information. In some embodiments, the connection request can request 5G standalone services from the network and in some other embodiments, the connection request can request 5G non-standalone services from the network. The connection request can be provided to and/or received by a gNodeB operating on the network. In some embodiments, the gNodeB can execute a priority service for assigning priority to traffic associated with the user equipment. It should be understood that this example embodiment is illustrative, and therefore should not be construed as being limiting in any way.

The priority service can be configured to detect the connection of the user equipment to the network (e.g., a request to attach to the network, a request for provisioning of service from the network, combinations thereof, or the like). The priority service also can examine the connection request to determine if the user equipment is requesting 5G standalone services or 5G non-standalone services. In various embodiments of the concepts and technologies disclosed herein, code and/or other information included in the connection request can be analyzed by the priority service to determine if 5G standalone features are being requested (or not). If the priority service determines that the user equipment requests 5G non-standalone services or features, the priority service can tunnel connections from the user equipment to a 4G core of the network (and/or other 4G functionality) to provide the requested services at a priority. In various embodiments, the priority can be set by the priority service by mapping a (“QoS”) class identifier (“QCI”) (e.g., as used for requests for 4G communications) included in the connection request to a (“5G”) QoS class identifier (“5QI”) (e.g., as used for requests for 5G communications) to maintain a QoS associated with the traffic. It should be understood that this example embodiment is illustrative, and therefore should not be construed as being limiting in any way.

If the priority service determines that the user equipment requests 5G standalone services or features, the priority service can be configured to increase or improve the priority of the traffic associated with the user equipment. In some embodiments, as noted above, this may be done to encourage users and/or devices to request 5G standalone services as a policy matter, though this is not necessarily the case. The priority service can be configured to example a priority profile, which may define how priority is to be mapped from a QCI to 5QI, and to adjust the priority associated with the traffic accordingly. It should be understood that in some embodiments, the priority profiles are optional and the adjustments to a priority associated with the traffic may be based on settings, configurations, or the like. At any rate, the priority service can tunnel connections from the user equipment to a 5G core of the network (and/or other 5G functionality) to provide the requested services at an adjusted priority. In various embodiments, the priority service can adjust the priority (e.g., increasing the priority associated with the traffic) by using a 5QI that is not currently used and/or that is shared with higher priority traffic (e.g., instead of mapping a QCI of eight or nine to a 5QI of eight or nine, the priority service can map a QCI of eight to a 5QI of two, or the like. Thus, traffic associated with a user equipment that requests 5G standalone services may have a better QoS than traffic associated with a user equipment that requests 5G non-standalone services in some embodiments. It should be understood that this example embodiment is illustrative, and therefore should not be construed as being limiting in any way.

According to various embodiments of the concepts and technologies disclosed herein, the gNodeB can monitor 5G standalone communications associated with a connection by directly monitoring the communications and/or by receiving information (e.g., traffic information) from a network monitor or other device that can monitor the traffic associated with the 5G standalone communications. The gNodeB can detect traffic congestion that exists on a portion of the network that is supporting the tunneled communications associated with the 5G standalone communications, where the traffic congestion may affect QoS associated with the communications.

The gNodeB can determine if the adjusted priority associated with the tunnel used for the 5G standalone traffic should be further adjusted to improve QoS. If the gNodeB determines that the adjusted priority associated with the tunneled communications (e.g., associated with the 5G standalone traffic) should not be further adjusted, the gNodeB can monitor the connection again until the gNodeB determines that the adjusted priority associated with the 5G standalone communications should be further adjusted. If the gNodeB determines that the adjusted priority associated with the tunneled communications (e.g., associated with the 5G standalone traffic) should be further adjusted, the gNodeB can obtain a priority profile or configuration or setting and determine when and/or how to adjust priority associated with the 5G standalone communications. The gNodeB can determine an adjustment to apply to the connection (e.g., a further adjustment to make to an adjusted priority associated with the communications to raise the adjusted priority further), and further adjust the adjusted priority and assign the (new) adjusted priority to the connection. Thus, the gNodeB can adjust priority during communications to maintain a QoS and/or for other purposes, according to some embodiments. It should be understood that this example embodiment is illustrative, and therefore should not be construed as being limiting in any way.

According to one aspect of the concepts and technologies disclosed herein, a system is disclosed. The system can include a processor and a memory. The memory can store computer-executable instructions that, when executed by the processor, cause the processor to perform operations. The operations can include detecting, at a gNodeB of a mobility network, a connection with a user equipment; and examining, by the gNodeB, a connection request associated with the user equipment. The connection request can include bearer information. The operations further can include determining, by the gNodeB, if the user equipment is requesting 5G standalone services; and if a determination is made that the user equipment is requesting the 5G standalone communications, adjusting, by the gNodeB, a priority to be used for the communications associated with the user equipment to obtain an adjusted priority for a connection associated with the 5G standalone communications, and tunneling, by the gNodeB, communications between the gNodeB and a 5G core of the mobility network. The communications associated with the 5G standalone communications can be provided by the mobility network at the adjusted priority. The operations further can include if a determination is made that the user equipment is requesting 5G non-standalone communications, directly mapping, by the gNodeB, a quality-of-service class identifier specified in the connection request to a 5G quality-of-service class identifier to be used as the priority for the communications associated with the user equipment, and tunneling, by the gNodeB, communications between the gNodeB and a 4G core of the mobility network. The communications associated with the 4G standalone communications can be provided by the mobility network at the priority.

In some embodiments, adjusting the priority can include raising the priority of the 5G standalone communications. In some embodiments, determining that the user equipment is requesting the 5G standalone communications can include analyzing the connection request and detecting, in the connection request, a request for a feature that is only available on a 5G standalone network. In some embodiments, determining that the user equipment is requesting the 5G standalone communications can include analyzing the connection request and detecting, in the connection request, a request for network slicing and a request relating to an interface that is only available on a 5G standalone network.

In some embodiments, the operations further can include monitoring tunneled communications associated with the 5G standalone services; detecting traffic congestion on a portion of the network that is used to support the tunneled communications; determining that the adjusted priority should be further adjusted to maintain a quality of service defined for the tunneled communications; and adjusting the adjusted priority to use for the tunneled communications, whereby the quality of service defined for the tunneled communications is satisfied. In some embodiments, further adjusting the adjusted priority can include using a value for the 5G quality-of-service class identifier. The value can otherwise be reserved for a feature that is not supported by the mobility network. In some embodiments, the value can include one and the feature can include a voice over new radio call.

According to another aspect of the concepts and technologies disclosed herein, a method is disclosed. The method can include detecting, at a gNodeB of a mobility network, a connection with a user equipment; and examining, by the gNodeB, a connection request associated with the user equipment. The connection request can include bearer information. The operations further can include determining, by the gNodeB, if the user equipment is requesting 5G standalone services; and if a determination is made that the user equipment is requesting the 5G standalone communications, adjusting, by the gNodeB, a priority to be used for the communications associated with the user equipment to obtain an adjusted priority for a connection associated with the 5G standalone communications, and tunneling, by the gNodeB, communications between the gNodeB and a 5G core of the mobility network. The communications associated with the 5G standalone communications can be provided by the mobility network at the adjusted priority. The operations further can include if a determination is made that the user equipment is requesting 5G non-standalone communications, directly mapping, by the gNodeB, a quality-of-service class identifier specified in the connection request to a 5G quality-of-service class identifier to be used as the priority for the communications associated with the user equipment, and tunneling, by the gNodeB, communications between the gNodeB and a 4G core of the mobility network. The communications associated with the 4G standalone communications can be provided by the mobility network at the priority.

In some embodiments, adjusting the priority can include raising the priority of the 5G standalone communications. In some embodiments, determining that the user equipment is requesting the 5G standalone communications can include analyzing the connection request and detecting, in the connection request, a request for a feature that is only available on a 5G standalone network. In some embodiments, determining that the user equipment is requesting the 5G standalone communications can include analyzing the connection request and detecting, in the connection request, a request for network slicing and a request relating to an interface that is only available on a 5G standalone network.

In some embodiments, the operations further can include monitoring tunneled communications associated with the 5G standalone services; detecting traffic congestion on a portion of the network that is used to support the tunneled communications; determining that the adjusted priority should be further adjusted to maintain a quality of service defined for the tunneled communications; and adjusting the adjusted priority to use for the tunneled communications, whereby the quality of service defined for the tunneled communications is satisfied. In some embodiments, further adjusting the adjusted priority can include using a value for the 5G quality-of-service class identifier. The value can otherwise be reserved for a feature that is not supported by the mobility network. In some embodiments, the value can include one and the feature can include a voice over new radio call.

According to yet another aspect of the concepts and technologies disclosed herein, a computer storage medium is disclosed. The computer storage medium can store computer-executable instructions that, when executed by a processor, cause the processor to perform operations. The operations can include detecting, at a gNodeB of a mobility network, a connection with a user equipment; and examining, by the gNodeB, a connection request associated with the user equipment. The connection request can include bearer information. The operations further can include determining, by the gNodeB, if the user equipment is requesting 5G standalone services; and if a determination is made that the user equipment is requesting the 5G standalone communications, adjusting, by the gNodeB, a priority to be used for the communications associated with the user equipment to obtain an adjusted priority for a connection associated with the 5G standalone communications, and tunneling, by the gNodeB, communications between the gNodeB and a 5G core of the mobility network. The communications associated with the 5G standalone communications can be provided by the mobility network at the adjusted priority. The operations further can include if a determination is made that the user equipment is requesting 5G non-standalone communications, directly mapping, by the gNodeB, a quality-of-service class identifier specified in the connection request to a 5G quality-of-service class identifier to be used as the priority for the communications associated with the user equipment, and tunneling, by the gNodeB, communications between the gNodeB and a 4G core of the mobility network. The communications associated with the 4G standalone communications can be provided by the mobility network at the priority.

In some embodiments, adjusting the priority can include raising the priority of the 5G standalone communications. In some embodiments, determining that the user equipment is requesting the 5G standalone communications can include analyzing the connection request and detecting, in the connection request, a request for a feature that is only available on a 5G standalone network. In some embodiments, determining that the user equipment is requesting the 5G standalone communications can include analyzing the connection request and detecting, in the connection request, a request for network slicing and a request relating to an interface that is only available on a 5G standalone network.

In some embodiments, the operations further can include monitoring tunneled communications associated with the 5G standalone services; detecting traffic congestion on a portion of the network that is used to support the tunneled communications; determining that the adjusted priority should be further adjusted to maintain a quality of service defined for the tunneled communications; and adjusting the adjusted priority to use for the tunneled communications, whereby the quality of service defined for the tunneled communications is satisfied. In some embodiments, further adjusting the adjusted priority can include using a value for the 5G quality-of-service class identifier. The value can otherwise be reserved for a feature that is not supported by the mobility network. In some embodiments, the value can include one and the feature can include a voice over new radio call.

Other systems, methods, and/or computer program products according to embodiments will be or become apparent to one with skill in the art upon review of the following drawings and detailed description. It is intended that all such additional systems, methods, and/or computer program products be included within this description and be within the scope of this disclosure.

### BRIEF DESCRIPTION OF THE DRAWINGS

FIG. 1 is a system diagram illustrating an illustrative operating environment for various embodiments of the concepts and technologies described herein.

FIG. 2A shows an example portion of code associated with the connection request, according to an example embodiment of the concepts and technologies disclosed herein.

FIG. 2B is a table showing an example mapping of QCI to 5QI, according to some embodiments.

FIG. 2C is a table showing aspects of adjusting priority of 5G standalone traffic at a gNodeB, according to some example embodiments of the concepts and technologies disclosed herein.

FIG. 3 is a flow diagram showing aspects of a method for adjusting priority of 5G standalone traffic at a gNodeB, according to an illustrative embodiment of the concepts and technologies described herein.

FIG. 4 is a flow diagram showing aspects of a method for adjusting priority of 5G standalone traffic at a gNodeB, according to another illustrative embodiment of the concepts and technologies described herein.

FIG. 5 schematically illustrates a network, according to an illustrative embodiment of the concepts and technologies described herein.

FIG. 6 is a block diagram illustrating an example computer system configured to provide a priority service for adjusting priority of 5G standalone traffic at a gNodeB, according to some illustrative embodiments of the concepts and technologies described herein.

FIG. 7 is a block diagram illustrating an example mobile device configured to interact with a gNodeB that can adjust priority of 5G standalone traffic, according to some illustrative embodiments of the concepts and technologies described herein.

FIG. 8 is a diagram illustrating a computing environment capable of implementing aspects of the concepts and technologies disclosed herein, according to some illustrative embodiments of the concepts and technologies described herein.

### DETAILED DESCRIPTION

The following detailed description is directed to adjusting priority of 5G standalone traffic at a gNodeB. A user equipment can connect to a network. The user equipment may request services from the network, for example via a connection request that may include bearer information and/or other information. In some embodiments, the connection request can request 5G standalone services from the network and in some other embodiments, the connection request can request 5G non-standalone services from the network. The connection request can be provided to and/or received by a gNodeB operating on the network. In some embodiments, the gNodeB can execute a priority service for assigning priority to traffic associated with the user equipment. It should be understood that this example embodiment is illustrative, and therefore should not be construed as being limiting in any way.

The priority service can be configured to detect the connection of the user equipment to the network (e.g., a request to attach to the network, a request for provisioning of service from the network, combinations thereof, or the like). The priority service also can examine the connection request to determine if the user equipment is requesting 5G standalone services or 5G non-standalone services. In various embodiments of the concepts and technologies disclosed herein, code and/or other information included in the connection request can be analyzed by the priority service to determine if 5G standalone features are being requested (or not). If the priority service determines that the user equipment requests 5G non-standalone services or features, the priority service can tunnel connections from the user equipment to a 4G core of the network (and/or other 4G functionality) to provide the requested services at a priority. In various embodiments, the priority can be set by the priority service by mapping a QCI included in the connection request to a 5QI to maintain a QoS associated with the traffic. It should be understood that this example embodiment is illustrative, and therefore should not be construed as being limiting in any way.

If the priority service determines that the user equipment requests 5G standalone services or features, the priority service can be configured to increase or improve the priority of the traffic associated with the user equipment. In some embodiments, as noted above, this may be done to encourage users and/or devices to request 5G standalone services as a policy matter, though this is not necessarily the case. The priority service can be configured to example a priority profile, which may define how priority is to be mapped from a QCI to 5QI, and to adjust the priority associated with the traffic accordingly. It should be understood that in some embodiments, the priority profiles are optional and the adjustments to a priority associated with the traffic may be based on settings, configurations, or the like. At any rate, the priority service can tunnel connections from the user equipment to a 5G core of the network (and/or other 5G functionality) to provide the requested services at an adjusted priority. In various embodiments, the priority service can adjust the priority (e.g., increasing the priority associated with the traffic) by using a 5QI that is not currently used and/or that is shared with higher priority traffic (e.g., instead of mapping a QCI of eight or nine to a 5QI of eight or nine, the priority service can map a QCI of eight to a 5QI of two, or the like. Thus, traffic associated with a user equipment that requests 5G standalone services may have a better QoS than traffic associated with a user equipment that requests 5G non-standalone services in some embodiments. It should be understood that this example embodiment is illustrative, and therefore should not be construed as being limiting in any way.

According to various embodiments of the concepts and technologies disclosed herein, the gNodeB can monitor 5G standalone communications associated with a connection by directly monitoring the communications and/or by receiving information (e.g., traffic information) from a network monitor or other device that can monitor the traffic associated with the 5G standalone communications. The gNodeB can detect traffic congestion that exists on a portion of the network that is supporting the tunneled communications associated with the 5G standalone communications, where the traffic congestion may affect QoS associated with the communications.

The gNodeB can determine if the adjusted priority associated with the tunnel used for the 5G standalone traffic should be further adjusted to improve QoS. If the gNodeB determines that the adjusted priority associated with the tunneled communications (e.g., associated with the 5G standalone traffic) should not be further adjusted, the gNodeB can monitor the connection again until the gNodeB determines that the adjusted priority associated with the 5G standalone communications should be further adjusted. If the gNodeB determines that the adjusted priority associated with the tunneled communications (e.g., associated with the 5G standalone traffic) should be further adjusted, the gNodeB can obtain a priority profile or configuration or setting and determine when and/or how to adjust priority associated with the 5G standalone communications. The gNodeB can determine an adjustment to apply to the connection (e.g., a further adjustment to make to an adjusted priority associated with the communications to raise the adjusted priority further), and further adjust the adjusted priority and assign the (new) adjusted priority to the connection. Thus, the gNodeB can adjust priority during communications to maintain a QoS and/or for other purposes, according to some embodiments. It should be understood that this example embodiment is illustrative, and therefore should not be construed as being limiting in any way.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

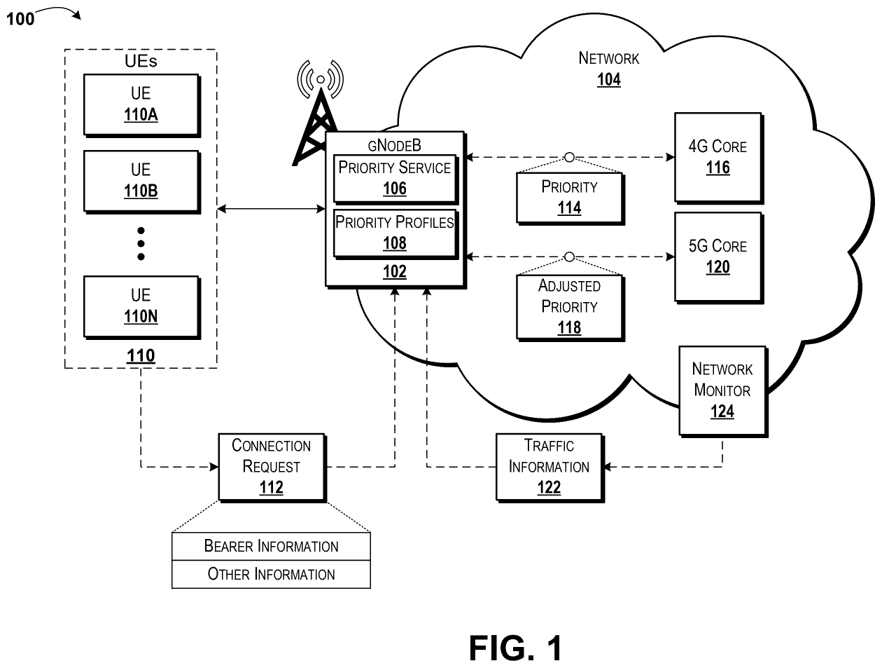

Referring now to FIG. 1, aspects of an operating environment 100 for various embodiments of the concepts and technologies disclosed herein for adjusting priority of 5G standalone traffic at a gNodeB will be described, according to an illustrative embodiment. The operating environment 100 shown in FIG. 1 includes a gNodeB 102. The gNodeB 102 can operate in communication with and/or as part of a communications network (“network”) 104 such as a mobility network, or the like.

According to various embodiments, the functionality of the gNodeB 102 may be provided by various devices and/or software modules executing on those devices as generally is understood. The gNodeB 102 can execute an operating system (not shown) and one or more application programs such as, for example, a priority service 106. The operating system can include a computer program that can control the operation of the gNodeB 102. The priority service 106 can include an executable program that can be configured to execute on top of the operating system to provide various functions as illustrated and described herein.

Although the priority service 106 is illustrated as executing on the gNodeB 102, it should be understood that the priority service 106 can be hosted by other devices and/or entities in the network 104 and can be configured to provide the functionality illustrated and described herein and/or to issue commands to the gNodeB 102. Thus, the priority service 106 may be embodied as or in one or more stand-alone device(s) or components thereof operating as part of or in communication with the network 104 and/or the gNodeB 102. As such, the illustrated embodiment should be understood as being illustrative of only some contemplated embodiments and should not be construed as being limiting in any way.

The priority service 106 can be configured to create and/or access one or more priority profiles 108. The priority profiles 108 can create a priority adjustment scheme for one or more connections between the gNodeB 102 and one or more devices such as, for example, user equipment 110A-N (hereinafter collectively and/or generically referred to as “user equipment 110”). As is generally understood, a user equipment 110 can connect to the gNodeB 102 via exchanging data with the gNodeB 102 such as, for example, a connection request 112. It can be appreciated that in various embodiments of the concepts and technologies disclosed herein, the connection request 112 can include a registration request or other message that may request services, one or more changes to services, provisioning requests, and/or other requests for connections and/or communications via the network 104. As shown in FIG. 1, the connection request 112 can include bearer information and other information. The bearer information can define, for example, whether the user equipment 110 is configured and/or requesting connection to the network 104 (via the gNodeB 102) for 5G standalone communications and/or 5G non-standalone communications.

It can be appreciated that if a user equipment 110 connects to the network 104 and/or gNodeB 102 requesting 5G non-standalone communications and/or connections, that the gNodeB 102 can be configured to assign a priority 114 to the communications and to tunnel communications associated with the user equipment 110 to and/or from a 4G core 116 of the network 104. Thus, for example, a user equipment 110 requesting 5G non-standalone communications may connect via the gNodeB 102 (e.g., using a 5G antenna and/or other hardware and the like), but other services may be provided by the 4G core 116. Thus, it can be appreciated that the user equipment 110 may not realize some of the benefits of 5G communications such as network slicing, higher speed (relative to 5G non-standalone and/or 4G communications) connection speeds, ultra-high-density communications, lower latency (relative to 5G non-standalone and/or 4G communications), improved security (relative to 5G non-standalone and/or 4G communications), other benefits, combinations thereof, or the like. It should be understood that this example embodiment is illustrative, and therefore should not be construed as being limiting in any way.

According to various embodiments, if a user equipment 110 connects to the network 104 and/or gNodeB 102 requesting 5G standalone communications and/or connections, the gNodeB 102 can be configured to determine and assign an adjusted priority 118 to the communications and to tunnel communications associated with the user equipment 110 to and/or from a 5G core 120 of the network 104. Thus, for example, a user equipment 110 requesting 5G standalone communications may connect via the gNodeB 102 (e.g., using a 5G antenna and/or other hardware and the like) and also can access the 5G core 120 and associated services and/or benefits. Furthermore, on the gNodeB 102, where the user equipment 110 may be competing for gNodeB 102 resources, the user equipment 110 will have an adjusted priority 118, which as will be explained in more detail herein can give the user equipment 110 higher priority than another user equipment 110 requesting 5G non-standalone communications. It should be understood that this example embodiment is illustrative, and therefore should not be construed as being limiting in any way.

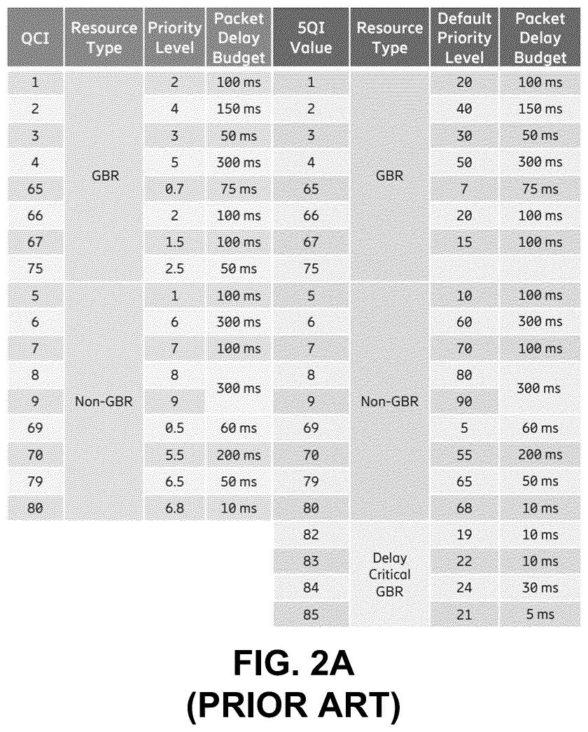

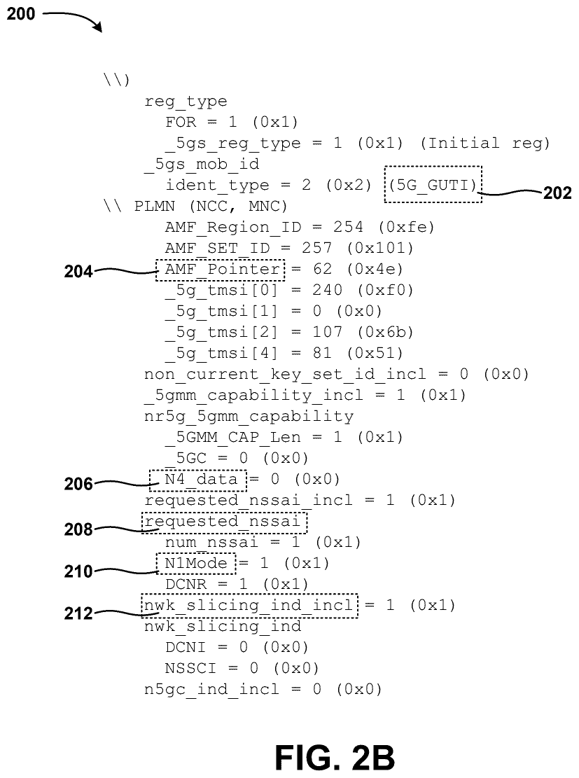

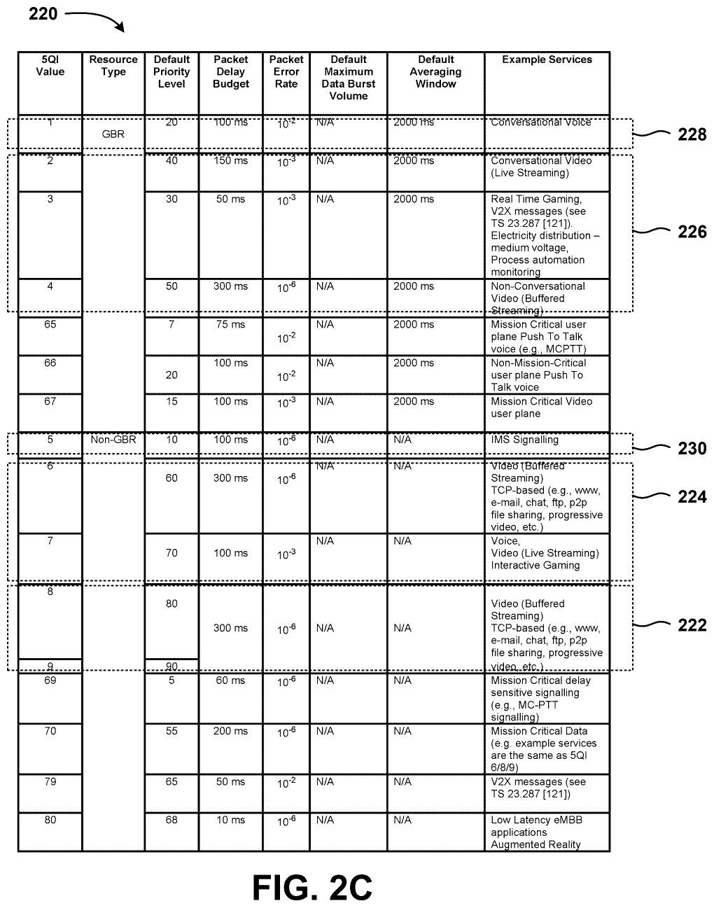

According to various embodiments of the concepts and technologies disclosed herein, the adjusted priority 118 can result in a higher priority for a user equipment 110 requesting 5G standalone communications relative to a lower priority for a user equipment 110 requesting 5G non-standalone communications. In particular, as will be illustrated and described in more detail herein, some embodiments of the network 104 can assign priority to communications associated with the user equipment 110 based on a mapping of quality of service (“QoS”) class identifier (“QCI”) for 4G communications to fifth generation (“5G”) QoS class identifier (“5QI”) for 5G communications. An example mapping of QCI to 5QI as used in some other technologies is shown in FIG. 2A. It should be understood that this example embodiment is illustrative, and therefore should not be construed as being limiting in any way.

In some embodiments that use a direct QCI to 5QI mapping, if a user equipment 110 requests non-standalone 5G communications, the priority assigned to the communications can be a direct mapping (e.g., a QCI equal to eight can be mapped to a 5QI equal to eight). In such an instance, a user equipment 110 connecting to the gNodeB 102 may have communications supported by the 4G core 116 and yet have the same priority on the gNodeB 102 and/or other portions of the network 104 as a user equipment 110 that requests 5G standalone communications. It should be understood that this example embodiment is illustrative, and therefore should not be construed as being limiting in any way.

For various reasons, network operators may wish to prioritize communications for one or more user equipment 110 that requests 5G standalone communications. Thus, embodiments of the concepts and technologies disclosed herein can include obtaining a priority profile 108, which can provide a priority adjustment scheme for communications of user equipment 110 that are requesting and/or engaging in 5G standalone communications via the gNodeB 102 and/or other components of the network 104. In particular, embodiments of the priority service 106 disclosed herein can be configured to assign an adjusted priority 118 to communications associated with a user equipment 110 that requests and/or is engaging in 5G standalone communications via the gNodeB 102. In some embodiments of the concepts and technologies disclosed herein, the adjusted priority 118 can be assigned from 5QI values that are either not being used for traffic and/or that are being used for limited traffic. In any event, the ability to assign an adjusted priority 118 that corresponds to a 5QI that is otherwise of limited use can result in the communications associated with user equipment 110 requesting 5G standalone services being granted higher priority and thereby, improved QoS. It should be understood that this example embodiment is illustrative, and therefore should not be construed as being limiting in any way.

The priority service 106 therefore can be configured to detect a connection. For example, the priority service 106 can detect a connection between a user equipment 110 and the gNodeB 102. In some embodiments, the connection can be detected via the gNodeB 102 receiving a connection request 112 and/or other message that requests attachment to the network 104, provisioning of services by the network 104, and/or the like. It should be understood that this example embodiment is illustrative, and therefore should not be construed as being limiting in any way.

The gNodeB 102 can be configured to examine the connection request 112. In some embodiments, the gNodeB 102 (via execution of the priority service 106) can examine bearer information included in the connection request 112 and determine, based on the bearer information and/or other information included in the connection request 112, if the user equipment 110 is requesting 5G standalone communications or 5G non-standalone communications. If the gNodeB 102 determines that the user equipment 110 is requesting 5G non-standalone communications, the gNodeB 102 can assign, to the communications associated with the user equipment 110, a priority 114 (which can be as specified in the connection request 112 and/or set on the services requested), and tunnel the communications to the 4G core 116. Thus, communications associated with the user equipment 110 may be serviced by the 4G core 116 in some instances. It should be understood that this example embodiment is illustrative, and therefore should not be construed as being limiting in any way.

If, however, the gNodeB 102 (e.g., via execution of the priority service 106) determines that the user equipment 110 is requesting 5G standalone communications, the gNodeB 102 can be configured to obtain a priority profile 108. The priority profile 108 can define a priority adjustment scheme, in some embodiments. The gNodeB 102 can (e.g., via execution of the priority service 106) examine the priority profile 108 and adjust a priority associated with the communications of the user equipment 110. The gNodeB 102 also can assign, to the communications associated with the user equipment 110, an adjusted priority 118 (which can be effectively higher than the priority as originally specified in the connection request 112 and/or as set based on the services requested by the user equipment 110). The gNodeB 102 also can be configured to tunnel the communications to the 5G core 120 while applying the adjusted priority 118 to the communications. Thus, communications associated with the user equipment 110 may be serviced by the 5G core 120 and have a higher priority than would have been granted if 5G non-standalone services had been requested. It should be understood that this example embodiment is illustrative, and therefore should not be construed as being limiting in any way.

According to various embodiments of the concepts and technologies disclosed herein, the priority service 106 also can be configured to dynamically update priority under certain circumstances. In particular, the gNodeB 102 (e.g., via execution of the priority service 106) can be configured to monitor 5G standalone communications associated with a user equipment 110. In some embodiments, the gNodeB 102 (e.g., via execution of the priority service 106) can be configured to directly monitor the communications associated with the user equipment 110 and to determine, based on the monitoring, that traffic congestion exists on the network 104 and/or at the gNodeB 102. In some other embodiments, the gNodeB 102 (e.g., via execution of the priority service 106) can be configured to obtain traffic information 122, for example from a network monitor 124. It should be understood that this example embodiment is illustrative, and therefore should not be construed as being limiting in any way.

The traffic information 122 can be analyzed by the gNodeB 102 to determine if any traffic congestion exists on the network 104 and/or at the gNodeB 102. If the gNodeB 102 (e.g., via execution of the priority service 106) determines that traffic congestion is impacting the quality of service provided to the user equipment 110, the gNodeB 102 can be configured to further adjust the adjusted priority 118 to improve quality of service for the user equipment 110. In particular, the gNodeB 102 (e.g., via execution of the priority service 106) can obtain the priority profile 108, determine an additional adjustment to make to the adjusted priority 118, and to assign the adjustment to create a new version of the adjusted priority 118. The gNodeB 102 can then conduct the communications at the further improved adjusted priority 118, thereby improving quality of service for the user equipment 110 requesting 5G standalone communications. It should be understood that this example embodiment is illustrative, and therefore should not be construed as being limiting in any way.

In practice, a user equipment 110 can connect to a network 104. The user equipment 110 may request services from the network 104, for example via a connection request 112 that may include bearer information and/or other information. In some embodiments, the connection request 112 can request 5G standalone services from the network 104 and in some other embodiments, the connection request 112 can request 5G non-standalone services from the network 104. The connection request can be provided to and/or received by a gNodeB 102 operating on the network 104. In some embodiments, the gNodeB 102 can execute a priority service 106 for assigning priority to traffic associated with the user equipment 110. It should be understood that this example embodiment is illustrative, and therefore should not be construed as being limiting in any way.

The priority service 106 can be configured to detect the connection of the user equipment 110 to the network 104 (e.g., a request to attach to the network 104, a request for provisioning of service from the network 104, combinations thereof, or the like). The priority service 106 also can examine the connection request 112 to determine if the user equipment 110 is requesting 5G standalone services or 5G non-standalone services. In various embodiments of the concepts and technologies disclosed herein, code and/or other information included in the connection request 112 can be analyzed by the priority service 106 to determine if 5G standalone features are being requested (or not). If the priority service 106 determines that the user equipment 110 requests 5G non-standalone services or features, the priority service 106 can tunnel connections from the user equipment 110 to a 4G core 116 of the network 104 (and/or other 4G functionality) to provide the requested services at a priority 114. In various embodiments, the priority 114 can be set by the priority service 106 by mapping a QCI included in the connection request 112 to a 5QI to maintain a QoS associated with the traffic. It should be understood that this example embodiment is illustrative, and therefore should not be construed as being limiting in any way.

If the priority service 106 determines that the user equipment 110 requests 5G standalone services or features, the priority service 106 can be configured to increase or improve the priority of the traffic associated with the user equipment 110. In some embodiments, as noted above, this may be done to encourage users and/or devices to request 5G standalone services as a policy matter, though this is not necessarily the case. The priority service 106 can be configured to example a priority profile 108, which may define how priority is to be mapped from a QCI to 5QI, and to adjust the priority associated with the traffic accordingly. It should be understood that in some embodiments, the priority profiles 108 are optional and the adjustments to a priority associated with the traffic may be based on settings, configurations, or the like. At any rate, the priority service 106 can tunnel connections from the user equipment 110 to a 5G core 120 of the network 104 (and/or other 5G functionality) to provide the requested services at an adjusted priority 118. In various embodiments, the priority service 106 can adjust the priority (e.g., increasing the priority associated with the traffic) by using a 5QI that is not currently used and/or that is shared with higher priority traffic (e.g., instead of mapping a QCI of eight or nine to a 5QI of eight or nine, the priority service 106 can map a QCI of eight to a 5QI of two, or the like). Thus, traffic associated with a user equipment 110 that requests 5G standalone services may have a better QoS than traffic associated with a user equipment 110 that requests 5G non-standalone services in some embodiments. It should be understood that this example embodiment is illustrative, and therefore should not be construed as being limiting in any way.

According to various embodiments of the concepts and technologies disclosed herein, the gNodeB 102 can monitor 5G standalone communications associated with a connection by directly monitoring the communications and/or by receiving information (e.g., traffic information 122) from a network monitor 124 or other device that can monitor the traffic associated with the 5G standalone communications. The gNodeB 102 can detect traffic congestion that exists on a portion of the network 104 that is supporting the tunneled communications associated with the 5G standalone communications, where the traffic congestion may affect QoS associated with the communications.

The gNodeB 102 can determine if the adjusted priority associated with the tunnel used for the 5G standalone traffic should be further adjusted to improve QoS. If the gNodeB 102 determines that the adjusted priority associated with the tunneled communications (e.g., associated with the 5G standalone traffic) should not be further adjusted, the gNodeB 102 can monitor the connection again until the gNodeB 102 determines that the adjusted priority associated with the 5G standalone communications should be further adjusted. If the gNodeB 102 determines that the adjusted priority associated with the tunneled communications (e.g., associated with the 5G standalone traffic) should be further adjusted, the gNodeB 102 can obtain a priority profile 108 or configuration or setting and determine when and/or how to adjust priority associated with the 5G standalone communications. The gNodeB 102 can determine an adjustment to apply to the connection (e.g., a further adjustment to make to an adjusted priority 118 associated with the communications to raise the adjusted priority 118 further), and further adjust the adjusted priority 118 and assign the (new) adjusted priority 118 to the connection. Thus, the gNodeB 102 can adjust priority during communications to maintain a QoS and/or for other purposes, according to some embodiments. It should be understood that this example embodiment is illustrative, and therefore should not be construed as being limiting in any way.

FIG. 1 illustrates one gNodeB 102, one network 104, three user equipment 110, one 4G core 116, one 5G core 120, and one network monitor 124. It should be understood, however, that various implementations of the operating environment 100 can include one or more than one gNodeB 102; one or more than one network 104; one or more than one user equipment 110; zero, one, or more than one 4G core 116; one or more than one 5G core 120; and/or zero, one, or more than one network monitor 124. As such, the illustrated embodiment should be understood as being illustrative, and should not be construed as being limiting in any way.

Turning now to FIG. 2B, a portion 200 of a connection request 112 is illustrated and described, according to an example embodiment of the concepts and technologies disclosed herein. As can be seen in FIG. 2B, the portion 200 of the connection request 112 can be analyzed to identify, in the portion 200 of the connection request 112, one or more request for a 5G service. Any such request for a 5G service (provided by the 5G core 120), can result in the connection request 112 being interpreted as corresponding to a request for 5G standalone services. Meanwhile, any connection request 112 that does not include a request for a 5G service provided by the 5G core 120 can result in the connection request 112 being interpreted as corresponding to a request for 5G non-standalone services. It should be understood that this example embodiment is illustrative, and therefore should not be construed as being limiting in any way.

In particular, in FIG. 2B, the example portion 200 of the connection request 112 includes a request 202 for a 5G globally unique temporary identity (“GUTI”), a request 202 that can indicate that the user equipment 110 wishes to communicate via the 5G core 120 (and therefore is requesting 5G standalone services). It should be understood that this example embodiment is illustrative, and therefore should not be construed as being limiting in any way. Similarly, the example portion 200 of the connection request 112 can include a request 204 that includes a pointer to an access and mobility management function (“AMF”), which, as is known, is a control plane function of a 5G network. Thus, this request 204 can similarly indicate that the user equipment 110 wishes to communicate via the 5G core 120 (and therefore is requesting 5G standalone services). It should be understood that this example embodiment is illustrative, and therefore should not be construed as being limiting in any way.

The example portion 200 of the connection request 112 also includes a request 206 for N4 data. As is known, the N4 interface is considered to be a fundamental component of 5G standalone services and therefore can also indicate that the user equipment 110 wishes to communicate via the 5G core 120 (and therefore is requesting 5G standalone services). It should be understood that this example embodiment is illustrative, and therefore should not be construed as being limiting in any way. Similarly, the example portion 200 of the connection request 112 can include several requests 208, 210, and 212 that can relate to network slice selection assistance information (“NSSAI”) and/or other aspects of network slicing. It can be appreciated that network slicing is a feature provided by 5G networks (and not 4G networks), so these requests 208, 210, 212 can similarly indicate that the user equipment 110 wishes to communicate via the 5G core 120 (and therefore is requesting 5G standalone services). It should be understood that this example embodiment is illustrative, and therefore should not be construed as being limiting in any way.

It should be understood that the illustrated portion 200 of the connection request 112 is purely illustrative and is provided merely to illustrate how the connection request 112 can be interpreted to request 5G standalone services and/or 5G non-standalone services in various embodiments. Because the connection request 112 can include different information and/or code, and because the portion 200 may be only one small portion of the connection request 112, it should be understood that this example embodiment is illustrative, and therefore should not be construed as being limiting in any way.

Turning now to FIG. 2C, additional aspects of adjusting priority of 5G standalone traffic at a gNodeB 102 are described in detail. in particular, FIG. 2C shows an example 5QI table 220. As can be seen, for example, a 5QI value of one can correspond to a request for a conversational voice (e.g., over a voice over new radio (“VoNR”)) session. As can be appreciated, however, some networks such as the network 104 may not yet be supporting VoNR, so a 5QI of one may not actually exist on a network 104. In some embodiments, the network 104 may support 5G services for user equipment 110 at a 5QI having a value of eight or nine, as shown generally at 222. Some other 5QI values may be reserved for emergency services, and the like, and therefore may be unavailable for users. Other values, however, such as the values shown generally at 224 and 226 (e.g., 5QI values of six to seven and 5QI values of two through four, respectively) may be available for assignment to 5G standalone communications by the gNodeB 102. As such, by selecting a 5QI value from the areas shown generally at 224 and 226 and assigning the associated 5QI priority value to the traffic, the gNodeB 102 can effectively raise the priority of the 5G standalone traffic (to priorities not otherwise being used and yet above the direct mapping that otherwise would exist, e.g., a 5QI value of eight or nine). It should be understood that this example embodiment is illustrative, and therefore should not be construed as being limiting in any way.

Still further, some embodiments of the network 104 may also not provide services that are associated with 5QI values of one and five, as indicated generally at 228 and 230. Thus, embodiments of the concepts and technologies disclosed herein can include the gNodeB 102 selecting a 5QI value from the areas shown generally at 228 and 230 (e.g., a 5QI of one or five) and assigning the associated 5QI priority value to the traffic. Thus, the gNodeB 102 can effectively raise the priority of the 5G standalone traffic (to priorities not otherwise being used and yet above the direct mapping that otherwise would exist, e.g., a 5QI value of eight or nine). As such, the gNodeB 102 can raise the priority of traffic and/or communications associated with user equipment 110 requesting 5G standalone communications in various embodiments. It should be understood that this example embodiment is illustrative, and therefore should not be construed as being limiting in any way.

As is explained in more detail herein, some embodiments of the concepts and technologies disclosed herein can use a concept of expansion zones (e.g., for 5QI) to address traffic congestion and/or to maintain QoS for 5G standalone communications. With reference to FIG. 2C, it can be appreciated that the area shown generally at 222 (e.g., corresponding to 5QI values of eight and nine) can correspond to a 5QI that can be applied to devices requesting 5G non-standalone services in accordance with embodiments of the concepts and technologies disclosed herein, and that the areas generally indicated at 224, 226, 228 and 230 (e.g., corresponding to 5QI values of one, two, three, four, five, six, and seven) can support adjusted priorities 118 and/or expansion zones used to address congestion. It should be understood that this example embodiment is illustrative, and therefore should not be construed as being limiting in any way.

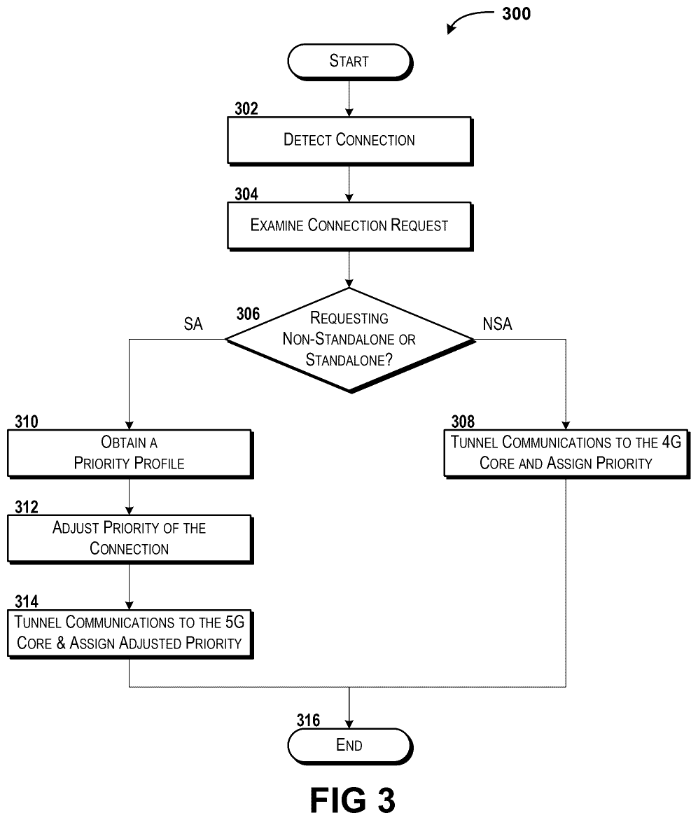

Turning now to FIG. 3, aspects of a method 300 for adjusting priority of 5G standalone traffic at a gNodeB will be described in detail, according to an illustrative embodiment. It should be understood that the operations of the methods disclosed herein are not necessarily presented in any particular order and that performance of some or all of the operations in an alternative order(s) is possible and is contemplated. The operations have been presented in the demonstrated order for case of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, such as the gNodeB 102, to perform one or more operations and/or causing the processor to direct other components of the computing system or device to perform one or more of the operations.

For purposes of illustrating and describing the concepts of the present disclosure, the method 300 is described herein as being performed by the gNodeB 102 via execution of one or more software modules such as, for example, the priority service 106. It should be understood that additional and/or alternative devices and/or network nodes can provide the functionality described herein via execution of one or more modules, applications, and/or other software including, but not limited to, the priority service 106. Thus, the illustrated embodiments are illustrative, and should not be viewed as being limiting in any way.

The method 300 begins at operation 302. At operation 302, the gNodeB 102 can detect a connection. In particular, in operation 302, the gNodeB 102 can detect a connection between the gNodeB 102 and a user equipment 110. The connection can correspond to a user equipment 110 requesting to attach to the network 104, requesting provisioning of services by the network 104, and/or otherwise initiating connections and/or communications with the network 104. In some embodiments, the functionality of operation 302 can correspond to the gNodeB 102 detecting a connection request 112. According to various embodiments of the concepts and technologies disclosed herein, the connection request 112 can include bearer information and/or other information that can be understood by the gNodeB 102 as requesting 5G standalone services or 5G non-standalone services, in some embodiments. It should be understood that this example embodiment is illustrative, and therefore should not be construed as being limiting in any way.

From operation 302, the method 300 can proceed to operation 304. At operation 304, the gNodeB 102 can examine the connection request 112 received in operation 302. As explained above, particularly with reference to FIG. 2B, information included in the connection request 112 can be understood as requesting 5G standalone services, 5G non-standalone services, or other services. For example, the gNodeB 102 can parse and/or analyze data included in the connection request 112 to determine if any 5G standalone services (e.g., network slicing, if specific 5G interfaces are referenced, advanced device support requests, or the like) are being requested. Because the connection request 112 can be analyzed in many other manners and/or for other types of requests (e.g., specific frequencies, or the like), it should be understood that the above example embodiments are illustrative, and therefore should not be construed as being limiting in any way.

From operation 304, the method 300 can proceed to operation 306. At operation 306, the gNodeB 102 can determine if the connection request obtained in operation 302 and examined in operation 304 is requesting standalone services or non-standalone services. It should be appreciated that the functionality of operation 306 can correspond to determining, based on the analysis of operation 304, if the user equipment 110 associated with the connection detected in operation 302 is requesting 5G standalone services or 5G non-standalone services. It should be understood that this example embodiment is illustrative, and therefore should not be construed as being limiting in any way.

If the gNodeB 102 determines, in operation 306, that the user equipment 110 is requesting non-standalone traffic, the method 300 can proceed to operation 308. At operation 308, the gNodeB 102 can establish a connection between the gNodeB 102 and a 4G core 116 of the network 104 (and/or other 4G devices and/or entities) and tunnel communications and/or traffic associated with the user equipment 110 (with which the connection detected in operation 302 is associated) between the gNodeB 102 and the 4G core 116. According to various embodiments, as shown in FIG. 1, the gNodeB 102 can assign a priority 114 to the tunneled communications. As noted above, the priority 114 can be assigned by mapping a QCI indicated in the connection request 112 to a 5QI and applying the 5QI to the communications. Thus, it can be appreciated that the user equipment 110 requesting the communications at a QCI that corresponds to a particular priority 114 (e.g., a QCI of eight) can be granted 5G non-standalone services by the gNodeB 102 at a 5QI of eight. It should be understood that this example embodiment is illustrative, and therefore should not be construed as being limiting in any way.

If the gNodeB 102 determines, in operation 306, that the user equipment 110 is requesting standalone traffic, the method 300 can proceed to operation 310. At operation 310, the gNodeB 102 can obtain a priority profile 108. According to various embodiments of the concepts and technologies disclosed herein, the priority profile 108 can specify how a QCI or 5QI specified in a connection request 112 may be mapped to a priority for use in providing the requested traffic to the user equipment 110 if the user equipment 110 is requesting 5G standalone services. According to various embodiments of the concepts and technologies disclosed herein, as explained above with reference to FIG. 2C, a 5QI of eight (for example) may be raised by the gNodeB 102 to a 5QI of two, three, four, six, or seven in some embodiments to increase the priority (and resulting QoS) associated with traffic for user equipment 110 requesting 5G standalone services. This adjusted priority 118 can be used to support traffic associated with the user equipment 110 in various embodiments. It should be understood that this example embodiment is illustrative, and therefore should not be construed as being limiting in any way.

From operation 310, the method 300 can proceed to operation 312. At operation 312, the gNodeB 102 can adjust a priority associated with the connection detected in operation 302. Thus, the tunnel between the gNodeB 102 and the 5G core 120 can have an adjusted priority 118 as illustrated and described above. From operation 312, the method 300 can proceed to operation 314. At operation 314, the gNodeB 102 can establish a connection between the gNodeB 102 and a 5G core 120 of the network 104 (and/or other 5G devices and/or entities) and tunnel communications associated with the user equipment 110 (associated with the connection detected in operation 302) from and between the gNodeB 102 and the 5G core 120 for the traffic. The gNodeB 102 also can assign the adjusted priority 118 as calculated in operation 312 to the communications, thereby improving QoS associated with the traffic. It should be understood that this example embodiment is illustrative, and therefore should not be construed as being limiting in any way.

From operation 314, the method 300 can proceed to operation 316. The method 300 also can proceed to operation 316 from operation 308. The method 300 can end at operation 316.

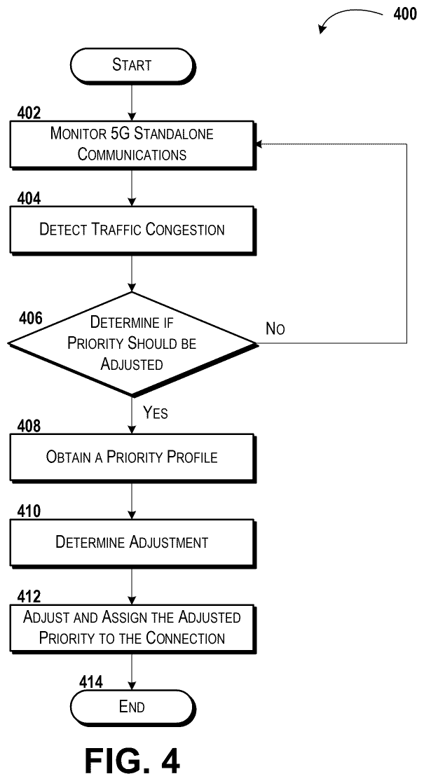

Turning now to FIG. 4, aspects of a method 400 for adjusting priority of 5G standalone traffic at a gNodeB will be described in detail, according to an illustrative embodiment. For purposes of illustrating and describing the concepts of the present disclosure, the method 400 is described herein as being performed by the gNodeB 102 via execution of one or more software modules such as, for example, the priority service 106. It should be understood that additional and/or alternative devices and/or network nodes can provide the functionality described herein via execution of one or more modules, applications, and/or other software including, but not limited to, the priority service 106. Thus, the illustrated embodiments are illustrative, and should not be viewed as being limiting in any way.

The method 400 begins at operation 402. At operation 402, the gNodeB 102 can monitor 5G standalone communications associated with a connection. For example, the gNodeB 102 can monitor, for example, tunneled communications associated with 5G standalone communications as established in operation 314 of the method 300 shown in FIG. 3. It should be understood that this example embodiment is illustrative, and therefore should not be construed as being limiting in any way.

In some embodiments of the concepts and technologies disclosed herein, operation 402 can correspond to the gNodeB 102 receiving information (e.g., traffic information 122) from a network monitor 124 or other device that can monitor the traffic associated with the 5G standalone communications. Thus, it can be appreciated that the gNodeB 102 can directly monitor the communications in some embodiments, or receive traffic information 122 from other entities that monitor the communications. Regardless of how the monitoring is done, operation 402 can correspond to the gNodeB 102 determining a state or condition of the 5G standalone communications.

From operation 402, the method 400 can proceed to operation 404. At operation 404, the gNodeB 102 can detect traffic congestion. Operation 404 can correspond to the gNodeB 102 determining, directly or based on the traffic information 122 or the like, that traffic congestion exists on a portion of the network 104 that is supporting the tunneled communications associated with the 5G standalone communications. In some embodiments of the concepts and technologies disclosed herein, it can be appreciated that the monitoring of the 5G standalone communications, detecting traffic congestion, and/or operations performed in response to detecting the congestion can be performed by the gNodeB 102 to further improve QoS associated with the 5G standalone communications, though this is not necessarily the case in all embodiments. It should be understood that this example embodiment is illustrative, and therefore should not be construed as being limiting in any way.

Operation 404 can correspond to the gNodeB 102 determining that traffic congestion exists on the network 104. The gNodeB 102 may also determine (or may assume) that this traffic congestion that is detected in operation 404 is or may interfere with the QoS associated with the adjusted priority 118 as provided for the 5G standalone communications. It should be understood that this example embodiment is illustrative, and therefore should not be construed as being limiting in any way.

From operation 404, the method 400 can proceed to operation 406. At operation 406, the gNodeB 102 can determine if the adjusted priority 118 associated with the tunnel used for the 5G standalone traffic should be further adjusted. Thus, for example, if the adjusted priority 118 corresponds to a 5QI of seven, for example, the gNodeB 102 can determine that additionally adjusting (e.g., raising and/or improving) the 5QI is available (e.g., to a 5QI of two, three, four, or six (or as noted above, perhaps even one or five in some instances)) and whether such a further adjustment is to be made. The gNodeB 102 can determine that further adjustments to the 5QI should be made if the QoS that is intended for the 5G standalone communications cannot be provided at the current 5QI and/or that additional adjustments to the adjusted priority 118 are available (and may improve the QoS). Because the gNodeB 102 can determine that additional adjustments are to be made in additional and/or alternative manners, it should be understood that these example embodiments are illustrative, and therefore should not be construed as being limiting in any way.

If the gNodeB 102 determines, in operation 406, that the adjusted priority 118 associated with the tunneled communications (e.g., associated with the 5G standalone traffic) should not be further adjusted, the method 300 can return to operation 402 and the gNodeB 102 can again monitor the connection. Thus, it can be appreciated that in some embodiments of the concepts and technologies disclosed herein, operations 402 through 406 can be iterated until the gNodeB 102 determines, in any iteration of operation 406, that the adjusted priority 118 associated with the 5G standalone communications should be adjusted (or until the 5G standalone communications that are being monitored have ended). It should be understood that this example embodiment is illustrative, and therefore should not be construed as being limiting in any way.

If the gNodeB 102 determines, in operation 406, that the adjusted priority 118 associated with the tunneled communications (e.g., associated with the 5G standalone traffic) should be further adjusted, the method 400 can proceed to operation 408. At operation 408, the gNodeB 102 can obtain a priority profile 108. As explained above, the priority profile 108 can define one or more rules (or conditions or the like) that can be used for determining when and/or how to adjust priority associated with the 5G standalone communications. In some embodiments, as noted above, the priority profiles 108 can be omitted and the gNodeB 102 can determine if and/or how to adjust priorities based on configurations, rules, settings, or the like. It should be understood that this example embodiment is illustrative, and therefore should not be construed as being limiting in any way.

From operation 408, the method 400 can proceed to operation 410. At operation 410, the gNodeB 102 can determine an adjustment to apply to the connection (e.g., a further adjustment to make to a priority associated with the communications to raise the adjusted priority 118 further). In some embodiments of the concepts and technologies disclosed herein, the gNodeB 102 can calculate and/or use priority expansion zones to provide the functionality of operation 408. In particular, while QCI can be directly mapped to 5QI in various embodiments, the gNodeB 102 illustrated and described herein can be configured to create priority expansion zones that can be used in the event of congestion.

Thus, for example, while a QCI of eight may by default be mapped to a 5QI of eight, an expansion zone including 5QIs two through four and/or six through seven can be selected from to support further prioritization of the tunneled communications associated with the 5G standalone communications in the event of traffic congestion (or in other cases), in some embodiments. In some instances, the gNodeB 102 can also determine if 5QIs one and five are being used or not. For example, if VoNR is not yet supported on a particular 5G network (e.g., the network 104), a 5QI of one may be available for use for prioritizing the communications. As such, it can be appreciated that the value for the 5QI as selected in operation 410 can correspond to a 5QI value for a feature that is not yet supported by the network 104 in some embodiments. It should be understood that this example embodiment is illustrative, and therefore should not be construed as being limiting in any way. At any rate, it can be appreciated that operation 410 can correspond to determining expansion zones (i.e., value ranges for 5QI) that can be used to prioritize communications. It should be understood that this example embodiment is illustrative, and therefore should not be construed as being limiting in any way.

From operation 410, the method 400 can proceed to operation 412. At operation 412, the gNodeB 102 can further adjust the adjusted priority 118 and assign the (new) adjusted priority 118 to the connection. It can be appreciated that operation 412 can correspond to the gNodeB 102 applying the adjustment determined in operation 410 to the communications. It should be understood that this example embodiment is illustrative, and therefore should not be construed as being limiting in any way.

From operation 412, the method 400 can proceed to operation 414. The method 400 can end at operation 414.

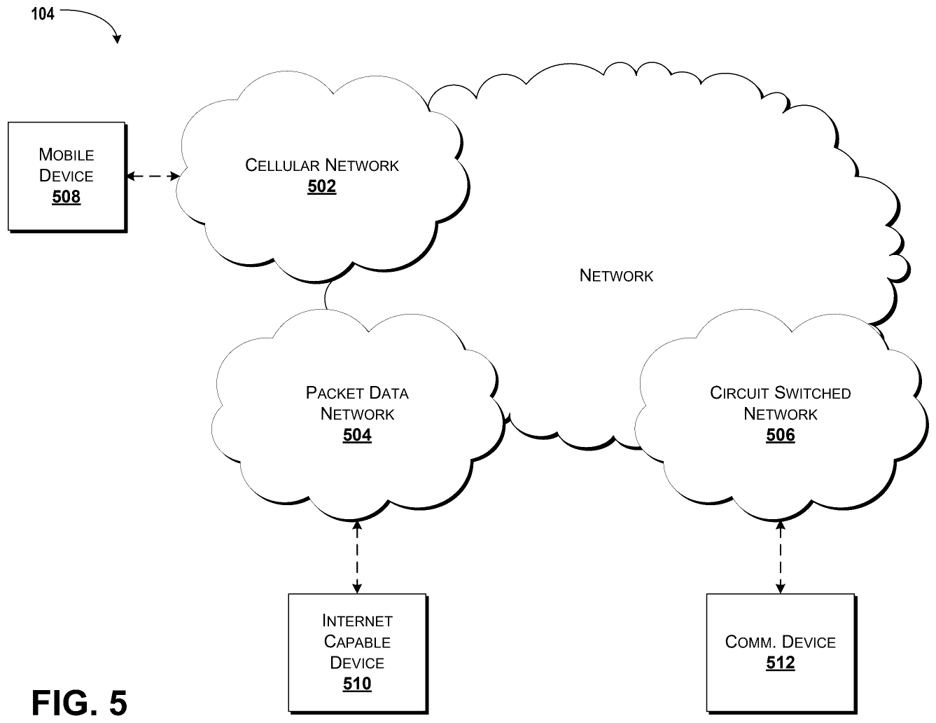

Turning now to FIG. 5, additional details of the network 104 are illustrated, according to an illustrative embodiment. The network 104 includes a cellular network 502, a packet data network 504, for example, the Internet, and a circuit switched network 506, for example, a publicly switched telephone network (“PSTN”). The cellular network 502 includes various components such as, but not limited to, base transceiver stations (“BTSs”), NodeB's or eNodeB's (“eNBs”), gNodeBs (“gNBs”), or the like; base station controllers (“BSCs”) radio network controllers (“RNCs”), or the like; an evolved packet core (“EPC”); mobile switching centers (“MSCs” or “MSSs”); session management functions (“SMFs); mobile management entities (“MMEs”); access and mobility management functions (“AMFs); authentication server functions (“AUSFs”), network slice selection functions (“NSSFs); network exposure functions (“NEFs”); policy control functions (“PCFs”); and various other functions in the user and control planes such as, for example, user plane functions (“UPFs), application functions (“AFs”), NF repository functions (“NRFs”), and the like; short message service centers (“SMSCs”); multimedia messaging service centers (“MMSCs”); home location registers (“HLRs”); home subscriber servers (“HSSs”); visitor location registers (“VLRs”); charging platforms; billing platforms; voicemail platforms; GPRS core network components; links to data networks (“DNs”) and/or other operator services, third party services, and/or the Internet; location service nodes, an IP Multimedia Subsystem (“IMS”); and the like. Of course, the cellular network 502 also can include various interfaces between various components, as is generally understood. The cellular network 502 also includes radios and nodes for receiving and transmitting voice, data, and combinations thereof to and from radio transceivers, networks, the packet data network 504, and the circuit switched network 506.

A mobile communications device 508, such as, for example, a cellular telephone, a user equipment, a mobile terminal, a PDA, a laptop computer, a handheld computer, and combinations thereof, can be operatively connected to the cellular network 502. The cellular network 502 can be configured as a 2G GSM network and can provide data communications via GPRS and/or EDGE. Additionally, or alternatively, the cellular network 502 can be configured as a 3G UMTS network and can provide data communications via the HSPA protocol family, for example, HSDPA, EUL (also referred to as HSUPA), and HSPA+. The cellular network 502 also is compatible with 4G mobile communications standards, 5G mobile communications standards, 6G mobile communication standards, other mobile communications standards, and evolved and future mobile communications standards.

The packet data network 504 includes various devices, for example, servers, computers, databases, and other devices in communication with one another, as is generally known. The packet data network 504 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 504 includes or is in communication with the Internet. The circuit switched network 506 includes various hardware and software for providing circuit switched communications. The circuit switched network 506 may include, or may be, what is often referred to as a plain old telephone system (POTS). The functionality of a circuit switched network 506 or other circuit-switched network are generally known and will not be described herein in detail.

The illustrated cellular network 502 is shown in communication with the packet data network 504 and a circuit switched network 506, though it should be appreciated that this is not necessarily the case. One or more Internet-capable devices 510, for example, a PC, a laptop, a portable device, or another suitable device, can communicate with one or more cellular networks 502, and devices connected thereto, through the packet data network 504. It also should be appreciated that the Internet-capable device 510 can communicate with the packet data network 504 through the circuit switched network 506, the cellular network 502, and/or via other networks (not illustrated).

As illustrated, a communications device 512, for example, a telephone, facsimile machine, modem, computer, or the like, can be in communication with the circuit switched network 506, and therethrough to the packet data network 504 and/or the cellular network 502. It should be appreciated that the communications device 512 can be an Internet-capable device, and can be substantially similar to the Internet-capable device 510. In the specification, the network 104 is used to refer broadly to any combination of the networks 502, 504, 506. It should be appreciated that substantially all of the functionality described with reference to the network 104 can be performed by the cellular network 502, the packet data network 504, and/or the circuit switched network 506, alone or in combination with other networks, network elements, and the like.

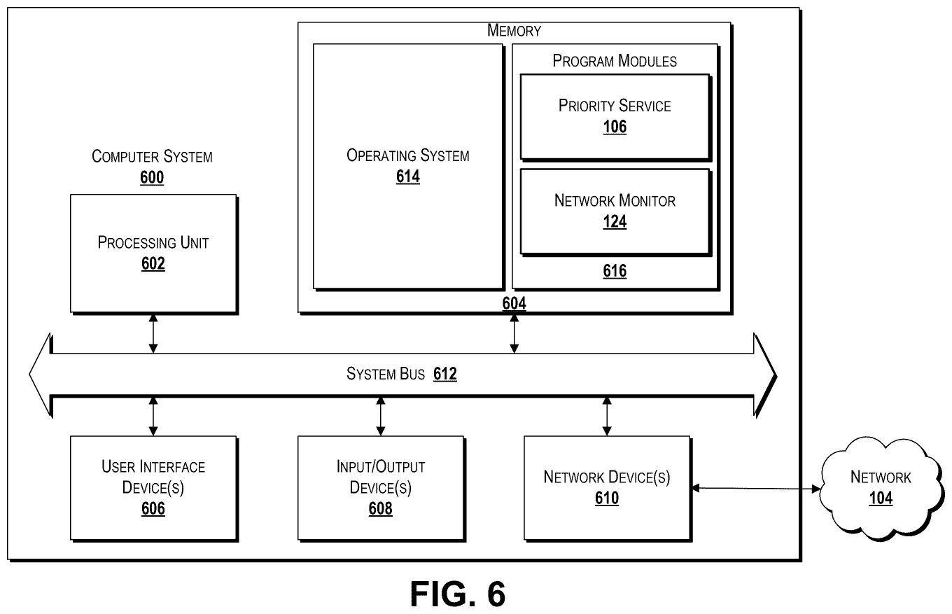

FIG. 6 is a block diagram illustrating a computer system 600 configured to provide the functionality described herein for adjusting priority of 5G standalone traffic at a gNodeB, in accordance with various embodiments of the concepts and technologies disclosed herein. Thus, it can be appreciated that the gNodeB 102 can have an architecture similar to the computer system 600 in some embodiments, though this is not the case in all embodiments. The computer system 600 includes a processing unit 602, a memory 604, one or more user interface devices 606, one or more input/output (“I/O”) devices 608, and one or more network devices 610, each of which is operatively connected to a system bus 612. The system bus 612 can enable bi-directional communication between the processing unit 602, the memory 604, the user interface devices 606, the I/O devices 608, and the network devices 610.

The processing unit 602 may be a standard central processor that performs arithmetic and logical operations, a more specific purpose programmable logic controller (“PLC”), a programmable gate array, or other type of processor known to those skilled in the art and suitable for controlling the operation of the server computer. As used herein, the word “processor” and/or the phrase “processing unit” when used with regard to any architecture or system can include multiple processors or processing units distributed across and/or operating in parallel in a single machine or in multiple machines. Furthermore, processors and/or processing units can be used to support virtual processing environments. Processors and processing units also can include state machines, application-specific integrated circuits (“ASICs”), combinations thereof, or the like. Because processors and/or processing units are generally known, the processors and processing units disclosed herein will not be described in further detail herein.

The memory 604 communicates with the processing unit 602 via the system bus 612. In some embodiments, the memory 604 is operatively connected to a memory controller (not shown) that enables communication with the processing unit 602 via the system bus 612. The memory 604 includes an operating system 614 and one or more program modules 616. The operating system 614 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, iOS, and/or SONOMA families of operating systems from APPLE CORPORATION, the FREEBSD family of operating systems, the SOLARIS family of operating systems from ORACLE CORPORATION, other operating systems, and the like.

The program modules 616 may include various software and/or program modules described herein. In some embodiments, for example, the program modules 616 include the priority service 106. This and/or other programs can be embodied in computer-readable media containing instructions that, when executed by the processing unit 602, perform one or more of the methods 300 and 400 described in detail above with respect to FIGS. 3-4 and/or other functionality as illustrated and described herein. It can be appreciated that, at least by virtue of the instructions embodying the methods 300 and 400 and/or other functionality illustrated and described herein being stored in the memory 604 and/or accessed and/or executed by the processing unit 602, the computer system 600 is a special-purpose computing system that can facilitate providing the functionality illustrated and described herein. According to embodiments, the program modules 616 may be embodied in hardware, software, firmware, or any combination thereof. Although not shown in FIG. 6, it should be understood that the memory 604 also can be configured to store the priority profiles 108, the connection request 112, the priority 114, the adjusted priority 118, the traffic information 122, and/or other data, if desired.

By way of example, and not limitation, computer-readable media may include any available computer storage media or communication media that can be accessed by the computer system 600. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Computer storage media includes only non-transitory embodiments of computer readable media as illustrated and described herein. Thus, computer storage media can include volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 600. In the claims, the phrase “computer storage medium” and variations thereof does not include waves or signals per se and/or communication media.

The user interface devices 606 may include one or more devices with which a user accesses the computer system 600. The user interface devices 606 may include, but are not limited to, computers, servers, personal digital assistants, cellular phones, or any suitable computing devices. The I/O devices 608 enable a user to interface with the program modules 616. In one embodiment, the I/O devices 608 are operatively connected to an I/O controller (not shown) that enables communication with the processing unit 602 via the system bus 612. The I/O devices 608 may include one or more input devices, such as, but not limited to, a keyboard, a mouse, or an electronic stylus. Further, the I/O devices 608 may include one or more output devices, such as, but not limited to, a display screen or a printer.

The network devices 610 enable the computer system 600 to communicate with other networks or remote systems via a network, such as the network 104. Examples of the network devices 610 include, but are not limited to, a modem, a radio frequency (“RF”) or infrared (“IR”) transceiver, a telephonic interface, a bridge, a router, or a network card. The network 104 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such as a WiMAX network, or a cellular network. Alternatively, the network 104 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

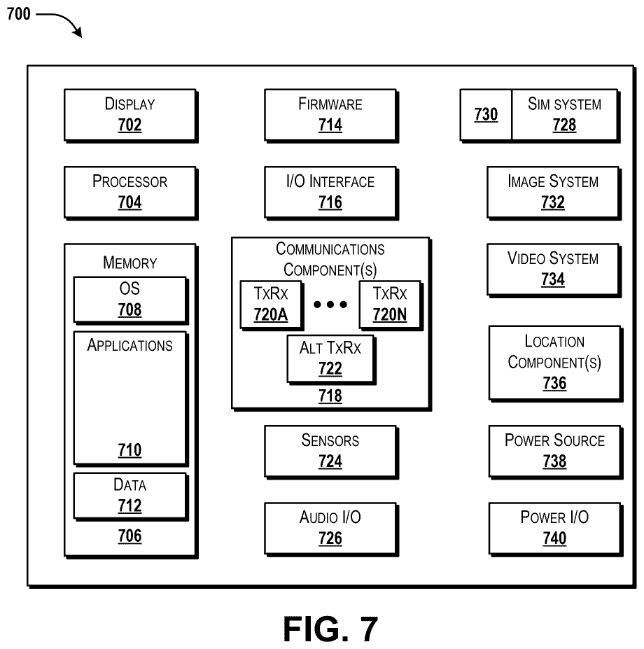

Turning now to FIG. 7, an illustrative mobile device 700 and components thereof will be described. In some embodiments, the user equipment 110 described above with reference to FIGS. 1-4 can be configured as and/or can have an architecture similar or identical to the mobile device 700 described herein in FIG. 7. It should be understood, however, that the user equipment 110 may or may not include the functionality described herein with reference to FIG. 7. While connections are not shown between the various components illustrated in FIG. 7, it should be understood that some, none, or all of the components illustrated in FIG. 7 can be configured to interact with one another to carry out various device functions. In some embodiments, the components are arranged so as to communicate via one or more busses (not shown). Thus, it should be understood that FIG. 7 and the following description are intended to provide a general understanding of a suitable environment in which various aspects of embodiments can be implemented, and should not be construed as being limiting in any way.

As illustrated in FIG. 7, the mobile device 700 can include a display 702 for displaying data. According to various embodiments, the display 702 can be configured to display various graphical user interface (“GUI”) elements such as, for example, text, images, video, virtual keypads and/or keyboards, messaging data, notification messages, metadata, internet content, device status, time, date, calendar data, device preferences, map and location data, combinations thereof, and/or the like. The mobile device 700 also can include a processor 704 and a memory or other data storage device (“memory”) 706. The processor 704 can be configured to process data and/or can execute computer-executable instructions stored in the memory 706. The computer-executable instructions executed by the processor 704 can include, for example, an operating system 708, one or more applications 710, other computer-executable instructions stored in a memory 706, or the like. In some embodiments, the applications 710 also can include a UI application (not illustrated in FIG. 7).

The UI application can interface with the operating system 708 to facilitate user interaction with functionality and/or data stored at the mobile device 700 and/or stored elsewhere. In some embodiments, the operating system 708 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 704 to aid a user in entering content, configuring settings, manipulating address book content and/or settings, multimode interaction, interacting with other applications 710, and otherwise facilitating user interaction with the operating system 708, the applications 710, and/or other types or instances of data 712 that can be stored at the mobile device 700. The data 712 can include, applications or program modules, in some embodiments. According to various embodiments, the data 712 can include, for example, presence applications, visual voice mail applications, messaging applications, text-to-speech and speech-to-text applications, add-ons, plug-ins, email applications, music applications, video applications, camera applications, location-based service applications, power conservation applications, game applications, productivity applications, entertainment applications, enterprise applications, combinations thereof, and the like. The applications 710, the data 712, and/or portions thereof can be stored in the memory 706 and/or in a firmware 714, and can be executed by the processor 704.

It can be appreciated that, at least by virtue of storage of the instructions corresponding to the applications 710 and/or other instructions embodying other functionality illustrated and described herein in the memory 706, and/or by virtue of the instructions corresponding to the applications 710 and/or other instructions embodying other functionality illustrated and described herein being accessed and/or executed by the processor 704, the mobile device 700 is a special-purpose mobile device that can facilitate providing the functionality illustrated and described herein. The firmware 714 also can store code for execution during device power up and power down operations. It can be appreciated that the firmware 714 can be stored in a volatile or non-volatile data storage device including, but not limited to, the memory 706 and/or a portion thereof.

The mobile device 700 also can include an input/output (“I/O”) interface 716. The I/O interface 716 can be configured to support the input/output of data such as location information, user information, organization information, presence status information, user IDs, passwords, and application initiation (start-up) requests. In some embodiments, the I/O interface 716 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ45 or RJ48) port, a telephone (RJ11 or the like) port, a proprietary port, combinations thereof, or the like. In some embodiments, the mobile device 700 can be configured to synchronize with another device to transfer content to and/or from the mobile device 700. In some embodiments, the mobile device 700 can be configured to receive updates to one or more of the applications 710 via the I/O interface 716, though this is not necessarily the case. In some embodiments, the I/O interface 716 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 716 may be used for communications between the mobile device 700 and a network device or local device.

The mobile device 700 also can include a communications component 718. The communications component 718 can be configured to interface with the processor 704 to facilitate wired and/or wireless communications with one or more networks such as the network 104 described herein. In some embodiments, other networks include networks that utilize non-cellular wireless technologies such as WI-FI or WIMAX. In some embodiments, the communications component 718 includes a multimode communications subsystem for facilitating communications via the cellular network and one or more other networks.

The communications component 718, in some embodiments, includes one or more transceivers. The one or more transceivers, if included, can be configured to communicate over the same and/or different wireless technology standards with respect to one another. For example, in some embodiments one or more of the transceivers of the communications component 718 may be configured to communicate using GSM, CDMAONE, CDMA2000, LTE, and various other 2G, 2.5G, 3G, 4G, 5G, 6G, and greater generation technology standards. Moreover, the communications component 718 may facilitate communications over various channel access methods (which may or may not be used by the aforementioned standards) including, but not limited to, TDMA, FDMA, W-CDMA, OFDM, SDMA, and the like.

In addition, the communications component 718 may facilitate data communications using GPRS, EDGE, the HSPA protocol family including HSDPA, EUL or otherwise termed HSUPA, HSPA+, and various other current and future wireless data access standards. In the illustrated embodiment, the communications component 718 can include a first transceiver (“TxRx”) 720A that can operate in a first communications mode (e.g., GSM). The communications component 718 also can include an Nth transceiver (“TxRx”) 720N that can operate in a second communications mode relative to the first transceiver 720A (e.g., UMTS). While two transceivers 720A-N (hereinafter collectively and/or generically referred to as “transceivers 720”) are shown in FIG. 7, it should be appreciated that less than two, two, and/or more than two transceivers 720 can be included in the communications component 718.

The communications component 718 also can include an alternative transceiver (“Alt TxRx”) 722 for supporting other types and/or standards of communications. According to various contemplated embodiments, the alternative transceiver 722 can communicate using various communications technologies such as, for example, WI-FI, WIMAX, BLUETOOTH, infrared, infrared data association (“IRDA”), near field communications (“NFC”), other RF technologies, combinations thereof, and the like. In some embodiments, the communications component 718 also can facilitate reception from terrestrial radio networks, digital satellite radio networks, internet-based radio service networks, combinations thereof, and the like. The communications component 718 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 700 also can include one or more sensors 724. The sensors 724 can include temperature sensors, light sensors, air quality sensors, movement sensors, orientation sensors, noise sensors, proximity sensors, or the like. As such, it should be understood that the sensors 724 can include, but are not limited to, accelerometers, magnetometers, gyroscopes, infrared sensors, noise sensors, microphones, combinations thereof, or the like. Additionally, audio capabilities for the mobile device 700 may be provided by an audio I/O component 726. The audio I/O component 726 of the mobile device 700 can include one or more speakers for the output of audio signals, one or more microphones for the collection and/or input of audio signals, and/or other audio input and/or output devices.

The illustrated mobile device 700 also can include a subscriber identity module (“SIM”) system 728. The SIM system 728 can include a universal SIM (“USIM”), a universal integrated circuit card (“UICC”) and/or other identity devices. The SIM system 728 can include and/or can be connected to or inserted into an interface such as a slot interface 730. In some embodiments, the slot interface 730 can be configured to accept insertion of other identity cards or modules for accessing various types of networks. Additionally, or alternatively, the slot interface 730 can be configured to accept multiple subscriber identity cards. Because other devices and/or modules for identifying users and/or the mobile device 700 are contemplated, it should be understood that these embodiments are illustrative, and should not be construed as being limiting in any way.

The mobile device 700 also can include an image capture and processing system (“image system”) 732. The image system 732 can be configured to capture or otherwise obtain photos, videos, and/or other visual information. As such, the image system 732 can include cameras, lenses, charge-coupled devices (“CCDs”), combinations thereof, or the like. The mobile device 700 may also include a video system 734. The video system 734 can be configured to capture, process, record, modify, and/or store video content. Photos and videos obtained using the image system 732 and the video system 734, respectively, may be added as message content to an MMS message, email message, and sent to another mobile device. The video and/or photo content also can be shared with other devices via various types of data transfers via wired and/or wireless communication devices as described herein.

The mobile device 700 also can include one or more location components 736. The location components 736 can be configured to send and/or receive signals to determine a geographic location of the mobile device 700. According to various embodiments, the location components 736 can send and/or receive signals from global positioning system (“GPS”) devices, assisted-GPS (“A-GPS”) devices, WI-FI/WIMAX and/or cellular network triangulation data, combinations thereof, and the like. The location component 736 also can be configured to communicate with the communications component 718 to retrieve triangulation data for determining a location of the mobile device 700. In some embodiments, the location component 736 can interface with cellular network nodes, telephone lines, satellites, location transmitters and/or beacons, wireless network transmitters and receivers, combinations thereof, and the like. In some embodiments, the location component 736 can include and/or can communicate with one or more of the sensors 724 such as a compass, an accelerometer, and/or a gyroscope to determine the orientation of the mobile device 700. Using the location component 736, the mobile device 700 can generate and/or receive data to identify its geographic location, or to transmit data used by other devices to determine the location of the mobile device 700. The location component 736 may include multiple components for determining the location and/or orientation of the mobile device 700.

The illustrated mobile device 700 also can include a power source 738. The power source 738 can include one or more batteries, power supplies, power cells, and/or other power subsystems including alternating current (“AC”) and/or direct current (“DC”) power devices. The power source 738 also can interface with an external power system or charging equipment via a power I/O component 740. Because the mobile device 700 can include additional and/or alternative components, the above embodiment should be understood as being illustrative of one possible operating environment for various embodiments of the concepts and technologies described herein. The described embodiment of the mobile device 700 is illustrative, and should not be construed as being limiting in any way.

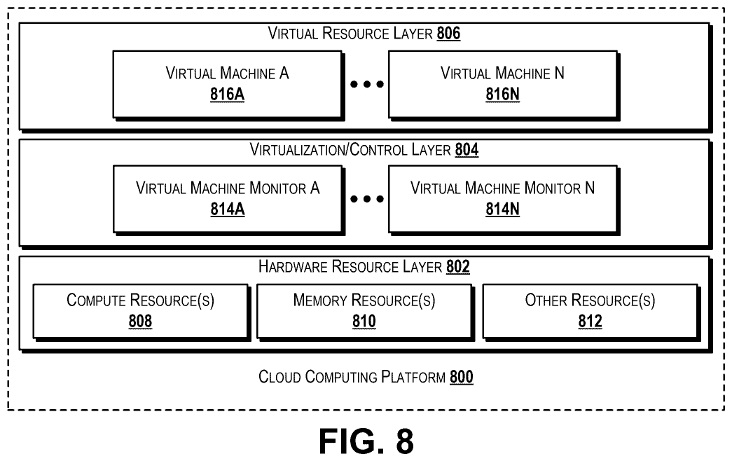

FIG. 8 illustrates an illustrative architecture for a cloud computing platform 800 that can be capable of executing the software components described herein for adjusting priority of 5G standalone traffic at a gNodeB and/or for interacting with the priority service 106. Thus, it can be appreciated that in some embodiments of the concepts and technologies disclosed herein, the cloud computing platform 800 illustrated in FIG. 8 can be used to provide at least some the functionality described herein with respect to one or more of the gNodeB 102, the 4G core 116, the 5G core 120, the network monitor 124, and/or other devices and/or entities or components thereof in various embodiments.

The cloud computing platform 800 thus may be utilized to execute any aspects of the software components presented herein. Thus, according to various embodiments of the concepts and technologies disclosed herein, the gNodeB 102 and/or the priority service 106 can be implemented, at least in part, on or by elements included in the cloud computing platform 800 illustrated and described herein. Those skilled in the art will appreciate that the illustrated cloud computing platform 800 is a simplification of but only one possible implementation of an illustrative cloud computing platform, and as such, the illustrated cloud computing platform 800 should not be construed as being limiting in any way.

In the illustrated embodiment, the cloud computing platform 800 can include a hardware resource layer 802, a virtualization/control layer 804, and a virtual resource layer 806. These layers and/or other layers can be configured to cooperate with each other and/or other elements of a cloud computing platform 800 to perform operations as will be described in detail herein. While connections are shown between some of the components illustrated in FIG. 8, it should be understood that some, none, or all of the components illustrated in FIG. 8 can be configured to interact with one another to carry out various functions described herein. In some embodiments, the components are arranged so as to communicate via one or more networks such as, for example, the network 104 illustrated and described hereinabove (not shown in FIG. 8). Thus, it should be understood that FIG. 8 and the following description are intended to provide a general understanding of a suitable environment in which various aspects of embodiments can be implemented, and should not be construed as being limiting in any way.

The hardware resource layer 802 can provide hardware resources. In the illustrated embodiment, the hardware resources can include one or more compute resources 808, one or more memory resources 810, and one or more other resources 812. The compute resource(s) 808 can include one or more hardware components that can perform computations to process data, and/or to execute computer-executable instructions of one or more application programs, operating systems, services, and/or other software including, but not limited to, the priority service 106 illustrated and described herein.

According to various embodiments, the compute resources 808 can include one or more central processing units (“CPUs”). The CPUs can be configured with one or more processing cores. In some embodiments, the compute resources 808 can include one or more graphics processing units (“GPUs”). The GPUs can be configured to accelerate operations performed by one or more CPUs, and/or to perform computations to process data, and/or to execute computer-executable instructions of one or more application programs, operating systems, and/or other software that may or may not include instructions that are specifically graphics computations and/or related to graphics computations. In some embodiments, the compute resources 808 can include one or more discrete GPUs. In some other embodiments, the compute resources 808 can include one or more CPU and/or GPU components that can be configured in accordance with a co-processing CPU/GPU computing model. Thus, it can be appreciated that in some embodiments of the compute resources 808, a sequential part of an application can execute on a CPU and a computationally-intensive part of the application can be accelerated by the GPU. It should be understood that this example is illustrative, and therefore should not be construed as being limiting in any way.

In some embodiments, the compute resources 808 also can include one or more system on a chip (“SoC”) components. It should be understood that an SoC component can operate in association with one or more other components as illustrated and described herein, for example, one or more of the memory resources 810 and/or one or more of the other resources 812. In some embodiments in which an SoC component is included, the compute resources 808 can be or can include one or more embodiments of the SNAPDRAGON brand family of SoCs, available from QUALCOMM of San Diego, California; one or more embodiment of the TEGRA brand family of SoCs, available from NVIDIA of Santa Clara, California; one or more embodiment of the HUMMINGBIRD brand family of SoCs, available from SAMSUNG of Seoul, South Korea; one or more embodiment of the Open Multimedia Application Platform (“OMAP”) family of SoCs, available from TEXAS INSTRUMENTS of Dallas, Texas; one or more customized versions of any of the above SoCs; and/or one or more other brand and/or one or more proprietary SoCs.

The compute resources 808 can be or can include one or more hardware components arranged in accordance with an ARM architecture, available for license from ARM HOLDINGS of Cambridge, United Kingdom. Alternatively, the compute resources 808 can be or can include one or more hardware components arranged in accordance with an x86 architecture, such as an architecture available from INTEL CORPORATION of Mountain View, California, and others. Those skilled in the art will appreciate the implementation of the compute resources 808 can utilize various computation architectures and/or processing architectures. As such, the various example embodiments of the compute resources 808 as mentioned hereinabove should not be construed as being limiting in any way. Rather, implementations of embodiments of the concepts and technologies disclosed herein can be implemented using compute resources 808 having any of the particular computation architecture and/or combination of computation architectures mentioned herein as well as other architectures.

Although not separately illustrated in FIG. 8, it should be understood that the compute resources 808 illustrated and described herein can host and/or execute various services, applications, portals, and/or other functionality illustrated and described herein. Thus, the compute resources 808 can host and/or can execute the priority service 106 or other applications or services illustrated and described herein.

The memory resource(s) 810 can include one or more hardware components that can perform or provide storage operations, including temporary and/or permanent storage operations. In some embodiments, the memory resource(s) 810 can include volatile and/or non-volatile memory implemented in any method or technology for storage of information such as computer-readable instructions, data structures, program modules, or other data disclosed herein. Computer storage media is defined hereinabove and therefore should be understood as including, in various embodiments, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium that can be used to store data and that can be accessed by the compute resources 808, subject to the definition of “computer storage media” provided above (e.g., as excluding waves and signals per se and/or communication media as defined in this application).

Although not illustrated in FIG. 8, it should be understood that the memory resources 810 can host or store the various data illustrated and described herein including, but not limited to, the priority profiles 108, the connection request 112, the priority 114, the adjusted priority 118, the traffic information 122, and/or other data, if desired. It should be understood that this example is illustrative, and therefore should not be construed as being limiting in any way.

The other resource(s) 812 can include any other hardware resources that can be utilized by the compute resources(s) 808 and/or the memory resource(s) 810 to perform operations. The other resource(s) 812 can include one or more input and/or output processors (e.g., a network interface controller and/or a wireless radio), one or more modems, one or more codec chipsets, one or more pipeline processors, one or more fast Fourier transform (“FFT”) processors, one or more digital signal processors (“DSPs”), one or more speech synthesizers, combinations thereof, or the like.

The hardware resources operating within the hardware resource layer 802 can be virtualized by one or more virtual machine monitors (“VMMs”) 814A-814N (also known as “hypervisors;” hereinafter “VMMs 814”). The VMMs 814 can operate within the virtualization/control layer 804 to manage one or more virtual resources that can reside in the virtual resource layer 806. The VMMs 814 can be or can include software, firmware, and/or hardware that alone or in combination with other software, firmware, and/or hardware, can manage one or more virtual resources operating within the virtual resource layer 806.

The virtual resources operating within the virtual resource layer 806 can include abstractions of at least a portion of the compute resources 808, the memory resources 810, the other resources 812, or any combination thereof. These abstractions are referred to herein as virtual machines (“VMs”). In the illustrated embodiment, the virtual resource layer 806 includes VMs 816A-816N (hereinafter “VMs 816”).

Based on the foregoing, it should be appreciated that systems and methods for adjusting priority of 5G standalone traffic at a gNodeB have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A system comprising:
a processor; and
a memory that stores computer-executable instructions that, when executed by the processor, cause the processor to perform operations comprising
detecting, at a gNodeB of a mobility network, a connection with a user equipment,
examining, by the gNodeB, a connection request associated with the user equipment, wherein the connection request comprises bearer information,
determining, by the gNodeB, if the user equipment is requesting 5G standalone services,
if a determination is made that the user equipment is requesting the 5G standalone communications,
adjusting, by the gNodeB, a priority to be used for the communications associated with the user equipment to obtain an adjusted priority for a connection associated with the 5G standalone communications, and
tunneling, by the gNodeB, communications between the gNodeB and a 5G core of the mobility network, wherein the communications associated with the 5G standalone communications are provided by the mobility network at the adjusted priority, and
if a determination is made that the user equipment is requesting 5G non-standalone communications,
directly mapping, by the gNodeB, a quality-of-service class identifier specified in the connection request to a 5G quality-of-service class identifier to be used as the priority for the communications associated with the user equipment, and
tunneling, by the gNodeB, communications between the gNodeB and a 4G core of the mobility network, wherein the communications associated with the 4G standalone communications are provided by the mobility network at the priority.

2. The system of claim 1, wherein adjusting the priority comprises raising the priority of the 5G standalone communications.

3. The system of claim 1, wherein determining that the user equipment is requesting the 5G standalone communications comprises analyzing the connection request and detecting, in the connection request, a request for a feature that is only available on a 5G standalone network.

4. The system of claim 1, wherein determining that the user equipment is requesting the 5G standalone communications comprises analyzing the connection request and detecting, in the connection request, a request for network slicing and a request relating to an interface that is only available on a 5G standalone network.

5. The system of claim 1, wherein the computer-executable instructions, when executed by the processor, cause the processor to perform operations comprising:
monitoring tunneled communications associated with the 5G standalone services;
detecting traffic congestion on a portion of the network that is used to support the tunneled communications;
determining that the adjusted priority should be further adjusted to maintain a quality of service defined for the tunneled communications; and
adjusting the adjusted priority to use for the tunneled communications, whereby the quality of service defined for the tunneled communications is satisfied.

6. The system of claim 1, wherein further adjusting the adjusted priority comprises using a value for the 5G quality-of-service class identifier, and wherein the value is otherwise reserved for a feature that is not supported by the mobility network.

7. The system of claim 6, wherein the value comprises one and wherein the feature comprises a voice over new radio call.

8. A method comprising:
detecting, at a gNodeB of a mobility network, a connection with a user equipment;
examining, by the gNodeB, a connection request associated with the user equipment, wherein the connection request comprises bearer information;
determining, by the gNodeB, if the user equipment is requesting 5G standalone services;
if a determination is made that the user equipment is requesting the 5G standalone communications,
adjusting, by the gNodeB, a priority to be used for the communications associated with the user equipment to obtain an adjusted priority for a connection associated with the 5G standalone communications, and
tunneling, by the gNodeB, communications between the gNodeB and a 5G core of the mobility network, wherein the communications associated with the 5G standalone communications are provided by the mobility network at the adjusted priority; and
if a determination is made that the user equipment is requesting 5G non-standalone communications,
directly mapping, by the gNodeB, a quality-of-service class identifier specified in the connection request to a 5G quality-of-service class identifier to be used as the priority for the communications associated with the user equipment, and
tunneling, by the gNodeB, communications between the gNodeB and a 4G core of the mobility network, wherein the communications associated with the 4G standalone communications are provided by the mobility network at the priority.

9. The method of claim 8, wherein adjusting the priority comprises raising the priority of the 5G standalone communications.

10. The method of claim 8, wherein determining that the user equipment is requesting the 5G standalone communications comprises analyzing the connection request and detecting, in the connection request, a request for a feature that is only available on a 5G standalone network.

11. The method of claim 8, wherein determining that the user equipment is requesting the 5G standalone communications comprises analyzing the connection request and detecting, in the connection request, a request for network slicing and a request relating to an interface that is only available on a 5G standalone network.

12. The method of claim 8, further comprising:
monitoring tunneled communications associated with the 5G standalone services;
detecting traffic congestion on a portion of the network that is used to support the tunneled communications;
determining that the adjusted priority should be further adjusted to maintain a quality of service defined for the tunneled communications; and
adjusting the adjusted priority to use for the tunneled communications, whereby the quality of service defined for the tunneled communications is satisfied.

13. The method of claim 8, wherein further adjusting the adjusted priority comprises using a value for the 5G quality-of-service class identifier, and wherein the value is otherwise reserved for a feature that is not supported by the mobility network.

14. A computer storage medium having computer-executable instructions stored thereon that, when executed by a processor, cause the processor to perform operations comprising:
detecting, at a gNodeB of a mobility network, a connection with a user equipment;
examining, by the gNodeB, a connection request associated with the user equipment, wherein the connection request comprises bearer information;
determining, by the gNodeB, if the user equipment is requesting 5G standalone services;
if a determination is made that the user equipment is requesting the 5G standalone communications,
adjusting, by the gNodeB, a priority to be used for the communications associated with the user equipment to obtain an adjusted priority for a connection associated with the 5G standalone communications, and
tunneling, by the gNodeB, communications between the gNodeB and a 5G core of the mobility network, wherein the communications associated with the 5G standalone communications are provided by the mobility network at the adjusted priority; and
if a determination is made that the user equipment is requesting 5G non-standalone communications,
directly mapping, by the gNodeB, a quality-of-service class identifier specified in the connection request to a 5G quality-of-service class identifier to be used as the priority for the communications associated with the user equipment, and
tunneling, by the gNodeB, communications between the gNodeB and a 4G core of the mobility network, wherein the communications associated with the 4G standalone communications are provided by the mobility network at the priority.

15. The computer storage medium of claim 14, wherein adjusting the priority comprises raising the priority of the 5G standalone communications.

16. The computer storage medium of claim 14, wherein determining that the user equipment is requesting the 5G standalone communications comprises analyzing the connection request and detecting, in the connection request, a request for a feature that is only available on a 5G standalone network.

17. The computer storage medium of claim 14, wherein determining that the user equipment is requesting the 5G standalone communications comprises analyzing the connection request and detecting, in the connection request, a request for network slicing and a request relating to an interface that is only available on a 5G standalone network.

18. The computer storage medium of claim 14, wherein the computer-executable instructions, when executed by the processor, cause the processor to perform operations comprising:
monitoring tunneled communications associated with the 5G standalone services;
detecting traffic congestion on a portion of the network that is used to support the tunneled communications;
determining that the adjusted priority should be further adjusted to maintain a quality of service defined for the tunneled communications; and
adjusting the adjusted priority to use for the tunneled communications, whereby the quality of service defined for the tunneled communications is satisfied.

19. The computer storage medium of claim 14, wherein further adjusting the adjusted priority comprises using a value for the 5G quality-of-service class identifier, and wherein the value is otherwise reserved for a feature that is not supported by the mobility network.

20. The computer storage medium of claim 19, wherein the value comprises one and wherein the feature comprises a voice over new radio call.
